(19) United States
(12) Patent Application Publication
(10) Pub. No.: US 2017/0019506 A1
(43) Pub. Date: Jan. 19, 2017

(54) SPDY-BASED WEB ACCELERATION METHOD AND SPDY PROXY THEREFOR

(71) Applicant: LG ELECTRONICS INC., Seoul (KR)

(72) Inventors: Seokhee LEE, Seoul (KR); Seongpyo HONG, Seoul (KR)

(73) Assignee: LG ELECTRONICS INC., Seoul (KR)

(21) Appl. No.: 15/124,875

(22) PCT Filed: Mar. 27, 2014
(86) PCT No.: PCT/KR2014/002597

§ 371 Date: Sep. 9, 2016

(51) Int. Cl. H04L 29/06; H04L 29/08

(52) U.S. Cl. CPC H04L 67/42; H04L 67/02; H04L 67/2847

(57) ABSTRACT

An SPDY-based web acceleration method in a web service including a client, a local SPDY proxy, a remote SPDY proxy and a web server. The method includes receiving, by the local SPDY proxy, a request for a web page from the client; determining, by the local SPDY proxy, if the requested web page or at least some resources constituting the web page have been cached in the local SPDY proxy; generating, by the local SPDY proxy, SPDY sessions with the remote SPDY proxy if the requested web page or at least some resources constituting the web page have not been cached in the local SPDY proxy; transmitting, by the local SPDY proxy, a request for the web page to the remote SPDY proxy through the generated SPDY sessions; determining, by the remote SPDY proxy, if the requested web page or at least some resources constituting the web page have been cached in the remote SPDY proxy; providing, by the remote SPDY proxy, the local SPDY proxy with the cached web page if the requested web page or at least some resources constituting the web page have been cached in the remote SPDY proxy; requesting, by the remote SPDY proxy, the web server for the web page if the requested web page or at least some resources constituting the web page have not been cached in the remote SPDY proxy; receiving, by the remote SPDY proxy and from the web server, resources constituting the web page corresponding to the request; and providing, by the remote SPDY proxy and the local SPDY proxy, the received web page to the client.

### CROSS REFERENCE TO THE RELATED APPLICATIONS

This application is the National Phase of PCT International Application No. PCT/KR2014/002597, filed on Mar. 27, 2014, which is hereby expressly incorporated by reference into the present application.

### BACKGROUND OF THE INVENTION

Field of the Invention

The present invention relates to an SPDY-based web acceleration method and an SPDY proxy therefor.

Description of the Related Art

Although HTTP had been issued as 1.0 version in 1996 and as 1.1 version in 1999 since 1991 when 0.9 version had been issued, HTTP has stagnated over 10 years without a new version. Since an HTTP protocol can process one HTTP request through one TCP session, if a user desires to download a web page which includes multi-resources, a problem occurs in that HTTP request should be processed as much as the number of resources. Also, since the HTTP protocol should establish TCP connection as much as the number of domains, a problem occurs in that transmission latency is increased. These problems of HTTP have not been solved up to now due to its slow advance.

Recently, with the increase of high-speed Internet services, user UX has been gradually improved, whereby a size of a web page, the number of resources constituting the web page, and the number of domains used by the web page have been gradually increased. For this reason, a problem occurs in that a web page, which supports multi-resources, cannot be transmitted efficiently by the HTTP protocol.

To solve such a problem, an SPDY (SPeeDY) protocol is recently applied to some web services. The SPDY protocol allows TCP connection to be used more efficiently by correcting a data transmission format and a connection management part of HTTP.

However, a web acceleration method in which prediction and pre-fetching are applied to an SPDY protocol has not been suggested up to now. In this respect, the present invention is to suggest a web acceleration method applicable to an SPDY protocol.

### SUMMARY OF THE INVENTION

An object of the present invention is to provide a web acceleration method applicable to SPDY through prediction and pre-fetching.

It will be appreciated by persons skilled in the art that the objects that could be achieved with the present invention are not limited to what has been particularly described hereinabove and the above and other objects that the present invention could achieve will be more clearly understood from the following detailed description.

To achieve the above object, a web acceleration method according to one embodiment of the present invention comprises the steps of receiving, by a remote SPDY proxy, a request for a web page from a client through SPDY sessions generated by a local SPDY proxy; and when the web page has not been cached or at least some resources constituting the web page have not been cached, receiving, by the remote SPDY proxy, resources constituting a web page corresponding to the request from a web server.

At this time, the local SPDY proxy may determine the number of the SPDY sessions, which will be generated, based on a network loss level which is measured.

Also, if the web page includes multi-domains, the remote SPDY proxy may receive the resources constituting the web page from each of the multi-domains through a plurality of SPDY channels.

Additionally, the remote SPDY proxy may perform pre-fetching for a resource, which is expected to be requested, although not requested by the client.

At this time, the remote SPDY proxy may predict the request of the client based on at least one of a browsing pattern and an HTML pattern of the client.

The remote SPDY proxy may perform converting for uniform resource locator (URL) addresses of the resource collected through the web server.

Also, the remote SPDY proxy may push data to the client regardless of the request of the client.

At this time, the remote SPDY proxy may measure a current network bandwidth, and may control a maximum size of the pushed data in accordance with the measured network bandwidth.

It will be appreciated by persons skilled in the art that the technical solutions that could be achieved with the present invention are not limited to what has been particularly described hereinabove and the above and other technical solutions that the present invention could achieve will be more clearly understood from the following detailed description.

According to the present invention, a web acceleration method applicable to SPDY through prediction and pre-fetching can be provided effectively.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

FIG. 1 is a diagram illustrating a typical TCP/IP layer model and SPDY layer model.

FIG. 2 is a diagram illustrating a web acceleration system based on an SPDY protocol according to the present invention.

FIG. 3 is a block diagram illustrating a local SPDY proxy.

FIG. 4 is a block diagram illustrating a remote SPDY proxy.

FIG. 5 is a flow chart illustrating an operation of a web acceleration method based on a local SPDY proxy and a remote SPDY proxy.

### DETAILED DESCRIPTION OF THE EMBODIMENTS

Hereinafter, a web acceleration method according to the present invention will be described in more detail with reference to the drawings. The suffixes “module” and “unit” for the elements used in the following description are given or used in common by considering facilitation in writing this disclosure only but fail to have meanings or roles discriminated from each other.

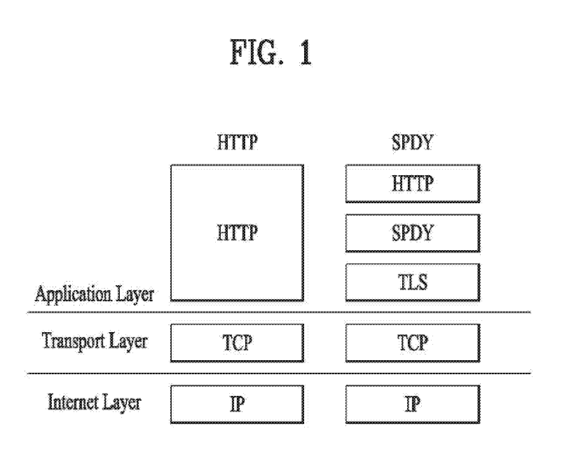

SPDY is an application layer protocol, and especially has been devised to minimize transmission latency. FIG. 1 is a diagram illustrating a typical TCP/IP layer model and SPDY layer model. As shown in FIG. 1, since SPDY is an application layer protocol and its lower layer uses TCP, the existing infrastructure may be used as it is. Furthermore, since general HTTP GET and POST message format types may be reserved equally, and TLS (Transport Layer Security) (or SSL (Secure Sockets Layer) and TCP are maintained, much cost is not required for application of SPDY. TLS is a next version of SSL, and SPDY may be stacked on either TLS or SSL.

The SPDY protocol can simultaneously process several HTTP requests through one TCP session. That is, unlike HTTP that processes only one request at one time and sequentially responds to the requests, the SPDY protocol can simultaneously process a plurality of requests and responses through a small number of connections. Therefore, the existing work-around system that separately generates connection for each domain can be avoided.

Also, unlike HTTP pipelining in which if one response is delayed, the other responses are all delayed, FIFO (First In, First Out) system may be adopted such that each request and each response are processed independently. Also, even though one stream is in progress, interleaving of another stream can be allowed, and priority between streams can be set such that data of high priority can be interleaved to be transmitted more quickly during transmission of data of low priority. For example, ‘html>js(java script)’ may be set such that priority of html resource is set to be higher than js resource, and ‘css>*’ may be set such that ‘css’ resource has the highest priority.

The SPDY protocol can serve to compress an HTTP header. Since many data are repeated per request in the HTTP header, it may be expected that throughput may be improved by header compression only. The SPDY protocol can compress the HTTP header by removing unnecessary data from the HTTP header or minimizing retransmission of repeated data.

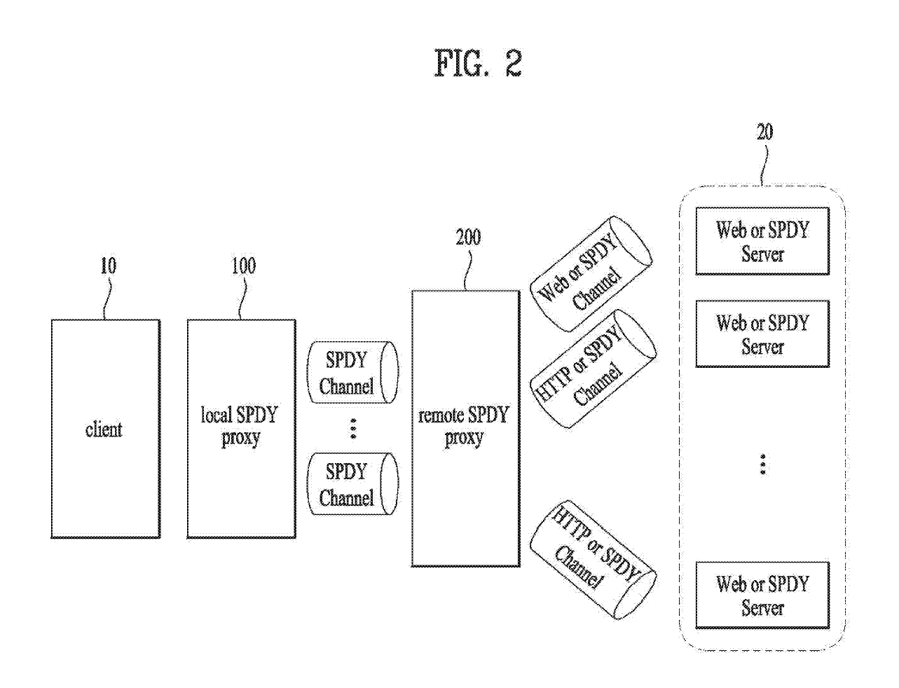

Conventionally, a server could transmit a content to a client 10 (FIG. 2) in response to a request of the client 10. However, if the SPDY protocol is used, the server can directly push the content even without a request of the client 10 unlike Comet, Long-Polling. Unlike an Inlining scheme, resource caching can be performed, and a bandwidth the same as or smaller than that of Inlining can be used.

A web acceleration system according to the present invention will be described in detail based on the aforementioned description of the SPDY protocol. In particular, FIG. 2 is a diagram illustrating a web acceleration system based on an SPDY protocol according to the present invention. Referring to FIG. 2, the web acceleration system includes a local SPDY proxy 100 and a remote SPDY proxy 200, which are located between the client 10 and a web server 20.

The client 10 cannot predict whether the web server 20 which will request a content is remotely located or whether to construct high transmission delay access with the web server 20. Therefore, transmission latency can be reduced through caching, prediction and pre-fetching of the local SPDY proxy 100 and the remote SPDY proxy 200.

The local SPDY proxy 100 may be applied to the client 10 (specifically, web browser) or a gateway to reduce transmission latency, and the remote SPDY proxy 200 may serve as a proxy server that receives a request from the client 10, receives a response to the request from the web server 20 and then transmits the received response to the client 10.

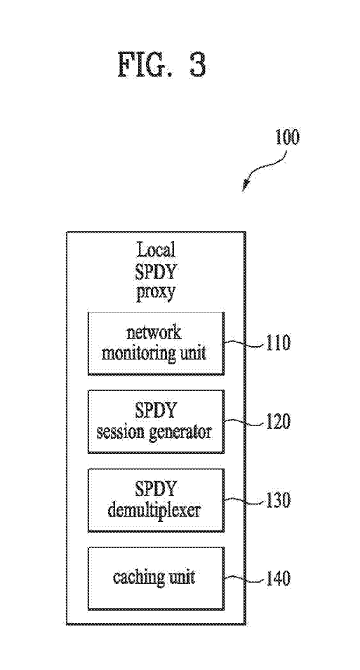

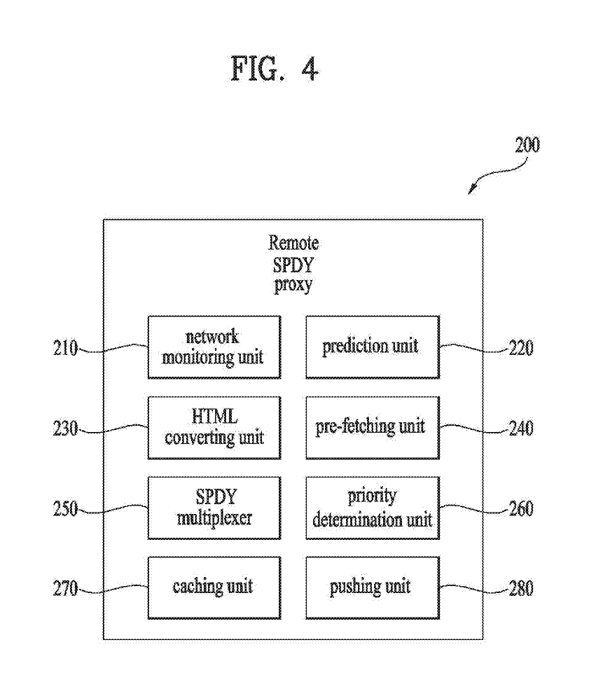

The local SPDY proxy 100 and the remote SPDY proxy 200 will be described in detail with reference to FIGS. 3 and 4. In particular, FIG. 3 is a block diagram illustrating a local SPDY proxy 100. Referring to FIG. 3, the local SPDY proxy 100 may include a network monitoring unit 110, an SPDY session generator 120, an SPDY demultiplexer 130, and a caching unit 140.

The network monitoring unit 110 monitors a network state before establishing SPDY sessions with the remote SPDY proxy, and determines the number of required SPDY sessions in accordance with the monitoring result. In more detail, the network monitoring unit 110 can identify a current network loss level and then determine the number of SPDY sessions, which are most efficient.

The SPDY session generator 120 can generate SPDY sessions based on the number of SPDY sessions determined through the network monitoring unit 110. The SPDY session generator 120 generates one session as default, and if a plurality of SPDY sessions are determined through the network monitoring unit 110, the SPDY session generator 12 can generate additional SPDY sessions. If a plurality of SPDY sessions are generated, the SPDY demultiplexer 130 can demultiplex data inserted from the plurality of SPDY sessions.

The caching unit 140 caches a web page previously accessed by the client 10. If the SPDY proxy receives a web access request through SPDY from the client 10, the SPDY proxy can first identify whether a web page desired to be accessed by itself is cached in the caching unit 140. If the web page desired to be accessed by the SPDY proxy is cached in the caching unit 140, the SPDY proxy can read the corresponding web page from the caching unit 140 and provide the client 10 with the read web page. If the web page desired to be accessed by the SPDY proxy is not cached in the caching unit 140, the SPDY proxy can request access to the web server 20.

FIG. 4 is a block diagram illustrating a remote SPDY proxy 200. Referring to FIG. 4, the remote SPDY proxy 200 includes a network monitoring unit 210, a prediction unit 220, an HTML converting unit 230, a pre-fetching unit 240, an SPDY multiplexer 250, a priority determination unit 260, a caching unit 270, and a pushing unit 280.

The network monitoring unit 210 can measure a bandwidth of a current network. The prediction unit 220 serves to predict a resource, which will be requested by the client, based on a browsing pattern and HTML pattern of the client 10. In this case, the browsing pattern means a content which a user who uses a web service mainly accesses, and the HTML pattern may relate to a resource of a web page, which is mainly accessed by users. For example, when a user uses a web page in which photo, moving picture, script, CSS file, other HTML page, etc. are embedded, if a pattern indicates that the user mainly accesses a photo file (based on the browsing pattern), the prediction unit 220 can predict that the photo file is a resource which will be requested by the client 10.

If it is predicted that users mainly access a moving picture file in view of a structure of the web page (based on HTML pattern), the prediction unit 220 may predict that the moving picture file is a resource which will be requested by the client 10. In addition, if the web page requested by the client 10 is a web page in which photo, script, CSS file, other HTML page, etc. are embedded, the prediction unit 220 may predict that objects embedded in the web page of the user are resources which will be requested by the client 10.

The pre-fetching unit 240 serves to receive the resource predicted by the prediction unit from the web server 20. In this case, the pre-fetching unit 240 can receive a resource linked to a specific web page from the web server 20, which stores the specific web page, and another web server 20 which stores the resource linked to the specific web page. That is, if a plurality of domains are used by the web page requested by the client 10, the pre-fetching unit 240 can receive the resource linked to the web page from the plurality of domains through a plurality of SPDY channels. In the following embodiments, it is expected by the prediction unit predicts that the client 10 will be required, whereby the resource previously received from the web server 20 will be referred to as a pre-fetched resource.

The HTML converting unit 230 serves to change resource URL addresses included in the web page like that resources existing in the plurality of web servers 20 are stored in the remote SPDY proxy 200. Therefore, the client 10 can recognize that the pre-fetched resource is stored in the remote SPDY proxy 200, and the pre-fetched resource can be requested through the remote SPDY proxy 200 not the web server 20.

The priority determination unit 260 serves to determine priority of data which will be transmitted to the client 20. Determination of priority can be controlled such that data of high priority can be interleaved to be transmitted more quickly during transmission of data of low priority. Since priority can dynamically be changed depending on a browsing status, priority of data transmission per object can be determined in accordance with a browsing pattern of a user.

The SPDY multiplexer 250 serves to distribute data through a plurality of channels if a plurality of SPDY sessions are constructed between the local SPDY proxy 100 and the remote SPDY proxy 200. The pushing unit 280 serves to push data to the client 10. As a result, data which are not requested by the client 10, can be transmitted to the client 10. At this time, the remote SPDY proxy 200 can transmit data to the client 10 through the pushing unit in accordance with a bandwidth measured by the network monitoring unit. The caching unit 270 serves to cache a resource which is previously accessed, and accelerate a web speed during reuse of the corresponding resource.

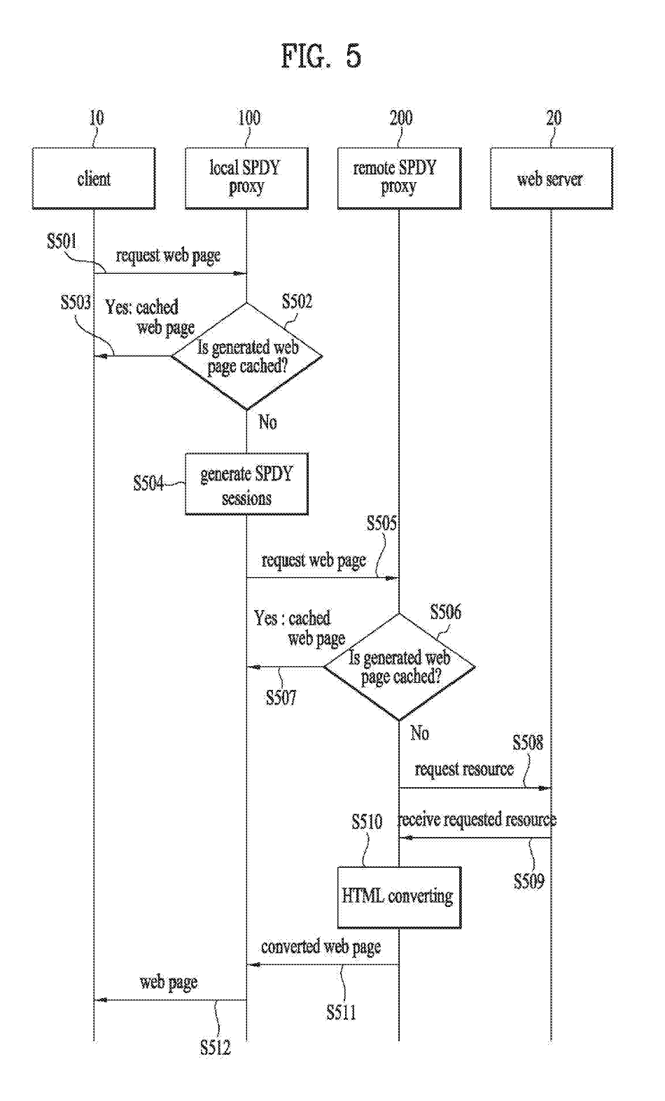

FIG. 5 is a flow chart illustrating an operation of a web acceleration method based on a local SPDY proxy 100 and a remote SPDY proxy 200. First of all, if a request of a web page through the client 10 is generated (S501), the local SPDY proxy 100 can identify whether the web page corresponding to the request is cached in the caching unit (S502).

If the requested web page is cached in the caching unit (Yes in S502), the local SPDY proxy 100 can provide the client 10 with the cached web page in response to the request (S503). Unlike this, if the requested web page is not cached in the caching unit (No in S502), the local SPDY proxy 100 can generate SPDY sessions with the remote SPDY proxy 200 (S504), and can transmit a request to the remote SPDY proxy 200 through the generated SPDY sessions (S505). At this time, the number of SPDY sessions can be determined depending on a network loss level measured by the network monitoring unit.

The remote SPDY proxy 200, which has received the request, can identify whether the web page corresponding to the request is cached in the caching unit (S506). If the requested web page or resource is cached in the caching unit (Yes in S506), the remote SPDY proxy 200 can provide the local SPDY proxy 100 with the cached web page in response to the request (S507).

Unlike this, if the requested web page is not cached in the caching unit (No in S506), the remote SPDY proxy 200 can request the web server 20 of the web page (S508). At this time, the remote SPDY proxy 200 can perform pre-fetching, which requests the web server 20, for resources expected to be requested by the client 10, although not requested by the client 10. Therefore, if the client 10 requests the resources pre-fetched on the web page later, the remote SPDY proxy 200 can immediately provide the resources requested by the client 10 without any request and response with the web server 20.

If the response is received from the web server 20 (S509), the remote SPDY proxy 200 can perform converting for HTML converting for converting URL addresses of the resources included in the web page (S510), and can transmit the web page, in which HTML converting has been performed, to the local SPDY proxy 100 (S511).

At this time, if a plurality of SPDY sessions exist between the local SPDY proxy 100 and the remote SPDY proxy 200, the remote SPDY proxy 200 can multiplex data transmission, and the local SPDY proxy 100 can receive the multiplexed data and then demultiplex the received data. The local SPDY proxy 100 can deliver the received web page to the client 10 (S512). Although not shown, the remote SPDY proxy can push data to the client 10 at any time if the client 10 does not request data.

According to one embodiment of the present invention, the aforementioned method (operation flow chart) may be implemented in a medium in which a program is recorded, as a code that can be read by a processor. Example of the medium that can be read by a processor include a ROM, a RAM, a CD-ROM, a magnetic tape, a floppy disk, and an optical data storage unit. Also, another example of the recording medium may be implemented in a type of carrier wave (for example, transmission through Internet).

The configurations and methods of the aforementioned embodiments are not limited to the local SPDY proxy 100 and the remote SPDY proxy 200 described as above, and all or some of the respective embodiments may be configured selectively in combination such that various modifications can be made in the embodiments.

The present invention may be applied to various web services to which an SPDY protocol is applied.

1. An SPDY-based web acceleration method in a web service including a client, a local SPDY proxy, a remote SPDY proxy and a web server, the method comprising:
receiving, by the local SPDY proxy, a request for a web page from the client;
determining, by the local SPDY proxy, if the requested web page or at least some resources constituting the web page have been cached in the local SPDY proxy;
generating, by the local SPDY proxy, SPDY sessions with the remote SPDY proxy if the requested web page or at least some resources constituting the web page have not been cached in the local SPDY proxy;
transmitting, by the local SPDY proxy, a request for the web page to the remote SPDY proxy through the generated SPDY sessions;
determining, by the remote SPDY proxy, if the requested web page or at least some resources constituting the web page have been cached in the remote SPDY proxy;
providing, by the remote SPDY proxy, the local SPDY proxy with the cached web page if the requested web page or at least some resources constituting the web page have been cached in the remote SPDY proxy;
requesting, by the remote SPDY proxy, the web server for the web page if the requested web page or at least some resources constituting the web page have not been cached in the remote SPDY proxy;
receiving, by the remote SPDY proxy and from the web server, resources constituting the web page corresponding to the request; and
providing, by the remote SPDY proxy and the local SPDY proxy, the received web page to the client.

2. The SPDY based web acceleration method according to claim 1, further comprising:
determining, by the local SPDY proxy, a number of the SPDY sessions, which will be generated, based on a measured network loss level.

3. The SPDY based web acceleration method according to claim 1, further comprising:
receiving, by the remote SPDY proxy, the resources constituting the web page from each multi-domain through a plurality of SPDY channels, in response to the web page including multi-domains.

4. The SPDY based web acceleration method according to claim 1, further comprising:
performing, by the remote SPDY proxy, pre-fetching for a resource, which is expected to be requested, without a request by the client.

5. The SPDY based web acceleration method according to claim 4, further comprising:
predicting, by the remote SPDY proxy, the request of the client based on at least one of a browsing pattern and an HTML pattern of the client.

6. The SPDY based web acceleration method according to claim 1, further comprising:
converting, by the remote SPDY proxy, uniform resource locator (URL) addresses of the resources collected through the web server.

7. The SPDY based web acceleration method according to claim 1, further comprising:
pushing, by the remote SPDY proxy data to the client regardless of the request of the client.

8. The SPDY based web acceleration method according to claim 6, herein claim 7, further comprising:
measuring, by the remote SPDY proxy, a current network bandwidth; and
controlling, by the remote SPDY proxy, a maximum size of the pushed data in accordance with the measured network bandwidth.

9. An SPDY-based web acceleration system in a web service, the system comprising:
a local SPDY proxy configured to receive a request for a web page from a client, determine if the requested web page or at least some resources constituting the web page have been cached in the local SPDY proxy, generate SPDY sessions with the remote SPDY proxy if the requested web page or at least some resources constituting the web page have not been cached in the local SPDY proxy, and transmit a request for the web page to the remote SPDY proxy through the generated SPDY sessions; and
a remote SPDY proxy configured to determine if the requested web page or at least some resources constituting the web page have been cached in the remote SPDY proxy, provide the local SPDY proxy with the cached web page if the requested web page or at least some resources constituting the web page have been cached in the remote SPDY proxy, request the web server for the web page if the requested web page or at least some resources constituting the web page have not been cached in the remote SPDY proxy, and receive resources constituting the web page corresponding to the request from the web server; and
wherein the received web page is provided to the client by the remote SPDY proxy and the local SPDY proxy.

10. The SPDY based web acceleration system according to claim 9, wherein the local SPDY proxy is further configured to determine a number of the SPDY sessions, which will be generated, based on a measured network loss level.

11. The SPDY based web acceleration system according to claim 9, wherein the remote SPDY proxy is further configured to receive the resources constituting the web page from each multi-domain through a plurality of SPDY channels, in response to the web page including multi-domains.

12. The SPDY based web acceleration system according to claim 9, wherein the remote SPDY proxy is further configured to perform pre-fetching for a resource, which is expected to be requested, without a request by the client.

13. The SPDY based web acceleration system according to claim 12, wherein the remote SPDY proxy is further configured to predict the request of the client based on at least one of a browsing pattern and an HTML pattern of the client.

14. The SPDY based web acceleration system according to claim 9, wherein the remote SPDY proxy is further configured to convert uniform resource locator (URL) addresses of the resources collected through the web server.

15. The SPDY based web acceleration system according to claim 9, wherein the remote SPDY proxy is further configured to push data to the client regardless of the request of the client.

16. The SPDY based web acceleration system according to claim 14, wherein the remote SPDY proxy is further configured to measure a current network bandwidth and control a maximum size of the pushed data in accordance with the measured network bandwidth.
